(19) United States
(12) Patent Application Publication
(10) Pub. No.: US 2016/0363971 A1
(43) Pub. Date: Dec. 15, 2016

(54) Combination Active/Passive Thermal Control

(71) Applicant: Microsoft Technology Licensing, LLC, Redmond, WA (US)

(72) Inventors: Andrew Douglas Delano, Woodinville, WA (US); Patrick Stephen Johnson, Olympia, WA (US); Guy Robert Wagner, Loveland, CO (US)

(21) Appl. No.: 14/734,833

(22) Filed: Jun. 9, 2015

(51) Int. Cl. G06F 1/20

(52) U.S. Cl. CPC G06F 1/206

(57) ABSTRACT

A thermal control system that includes a combination of active and passive components is described herein. In one or more implementation, the thermal control system compensates for non-uniformities in a temperature profile for an arrangement of components within a computing device. One or more active components of the thermal control system transfer heat away from heat-generating devices by active means, such as active transfer to a moving fluid that is driven by a blower or fan. Additionally, one or more passive components are positioned to transfer heat to selected areas of the device using passive transfer devices, such as heat-pipes and thermal spreaders made of conductive materials. The active and passive components operate together to compensate for temperature variations across the device surfaces, produce a controlled temperature profile having greater uniformity, reduce overall differences in surface temperatures, and provide greater capability for heat dissipation.

### BACKGROUND

Computing devices may include various electronic components that produce heat during operation (e.g., heat-generating devices), such as central processing units, graphical processing units, and so forth. Since such devices can be damaged by overheating and users should be protected from burns and discomfort, the computing device may include a thermal control system. In traditional arrangements for thermal control, large heat gradients may exist on external surfaces of device due to inadequate heat spreading. In modern device designs, thin form factors make it difficult to transfer heat sufficiently to produce a uniform or near uniform temperature profile across surfaces of the device. Consequently, hot spots may be created that approach safe temperature operating limits and device performance may be degraded due to control actions (power throttling, a shutdown failsafe, etc.) taken to mitigate unsafe temperatures and variations.

### SUMMARY

A thermal control system for a computing device that includes a combination of active and passive components is described herein. In one or more implementation, the thermal control system is configured to compensate for non-uniformities in a temperature profile for an arrangement of components within a housing of the computing device. One or more active components of the thermal control system operate to transfer heat away from heat-generating devices by active heat transfer, such as active transfer to a moving fluid (e.g., air, coolant) that is driven by a blower, fan, or other fluid mover. Additionally, one or more passive components are positioned to transfer heat to selected areas of the device using passive transfer devices, such as heat-pipes and thermal spreaders made of conductive materials. The active and passive components operate together to compensate for temperature variations across the device surfaces and produce a controlled temperature profile having greater uniformity and reduced overall differences in surface temperatures (e.g., a lower maximum temperature and a tighter range of temperatures).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an operating environment that is operable to employ a thermal control system in accordance with one or more implementations.

FIG. 2 depicts an example of a thermal control system of FIG. 1 in accordance with one or more implementations.

FIG. 3 depicts an example arrangement of a thermal control system in accordance with one or more implementations.

FIG. 4 depicts another example arrangement of a thermal control system in accordance with one or more implementations.

FIG. 5 depicts another example arrangement of a thermal control system in accordance with one or more implementations.

FIG. 6 is a diagram depicting an example showing a comparison of temperature profiles for representative arrangements of thermal control systems in accordance with one or more implementations.

FIG. 7 is a flow diagram that depicts an example procedure for configuring a thermal control system in accordance with one or more implementations.

FIG. 8 illustrates an example system including various components of an example device that can be implemented as any type of computing device as described with reference to FIGS. 1-7 to implement aspects of the techniques described herein.

### DETAILED DESCRIPTION

Overview

In modern device designs, thin form factors make it difficult to transfer heat sufficiently to produce a uniform or near uniform temperature profile across surfaces of the device. Consequently, hot spots may be created that approach safe temperature limits and device performance may be degraded due to control actions (power throttling, a shutdown failsafe, etc.) taken to mitigate unsafe temperatures and variations.

A thermal control system for a computing device that includes a combination of active and passive components is described herein. In one or more implementation, the thermal control system is configured to compensate for non-uniformities in a temperature profile for an arrangement of components within a housing of the computing device. One or more active components of the thermal control system operate to transfer heat away from heat-generating components by active heat transfer, such as active transfer to a moving fluid (e.g., air, coolant) that is driven by a blower, fan, or other fluid mover. Additionally, one or more passive components are positioned to transfer heat to selected areas of the device using passive transfer devices, such as heat-pipes and thermal spreaders made of conductive materials. The active and passive components operate together to compensate for temperature variations across the device surfaces and produce a controlled temperature profile having greater uniformity and reduced overall differences in surface temperatures (e.g., a lower maximum temperature and a tighter range of temperatures).

Balancing the temperature profile of a device in the manner described herein optimally distributes heat to device surfaces and makes use of more of the available surface area of the device, which increases the effectiveness and efficiency of the thermal control system. Additionally, the device is able to operate with lower overall temperatures and/or for longer periods of time without reaching critical temperatures. Consequently, device performance is improved since a processing system and other heat-generating devices can be operated at or near maximum levels for long periods of time without having to take control actions due to thermal constraints. Additionally, hot spots that could exceed safe operating conditions and/or degrade performance can be avoided.

In the following discussion, an example environment is first described that may employ the heat transfer techniques described herein. Example details and procedures are then described which may be performed in the example environment as well as other environments. Consequently, the details and procedures are not limited to the example environment and the example environment is not limited to implementation of the example details and procedures.

Example Operating Environment

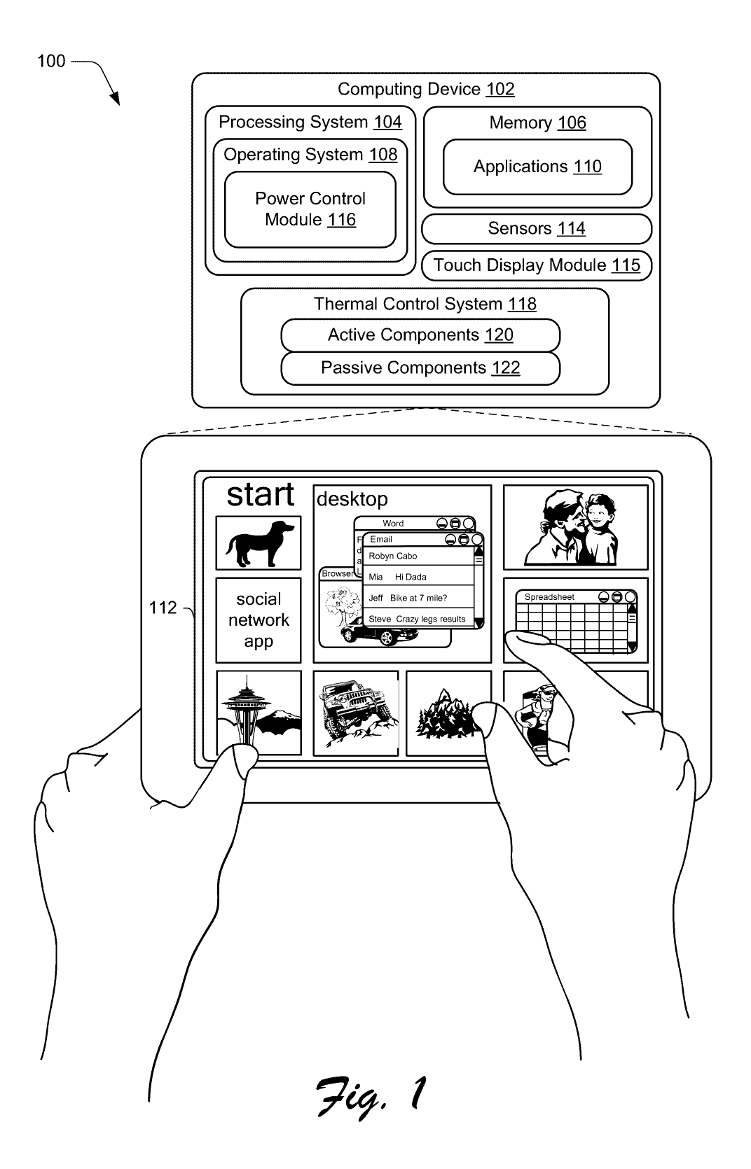

FIG. 1 is an illustration of an environment 100 in an example implementation that is operable to employ techniques described herein. The illustrated environment 100 includes a computing device 102 having a processing system 104 and a computer-readable storage medium that is illustrated as a memory 106 although other configurations are also contemplated as further described below.

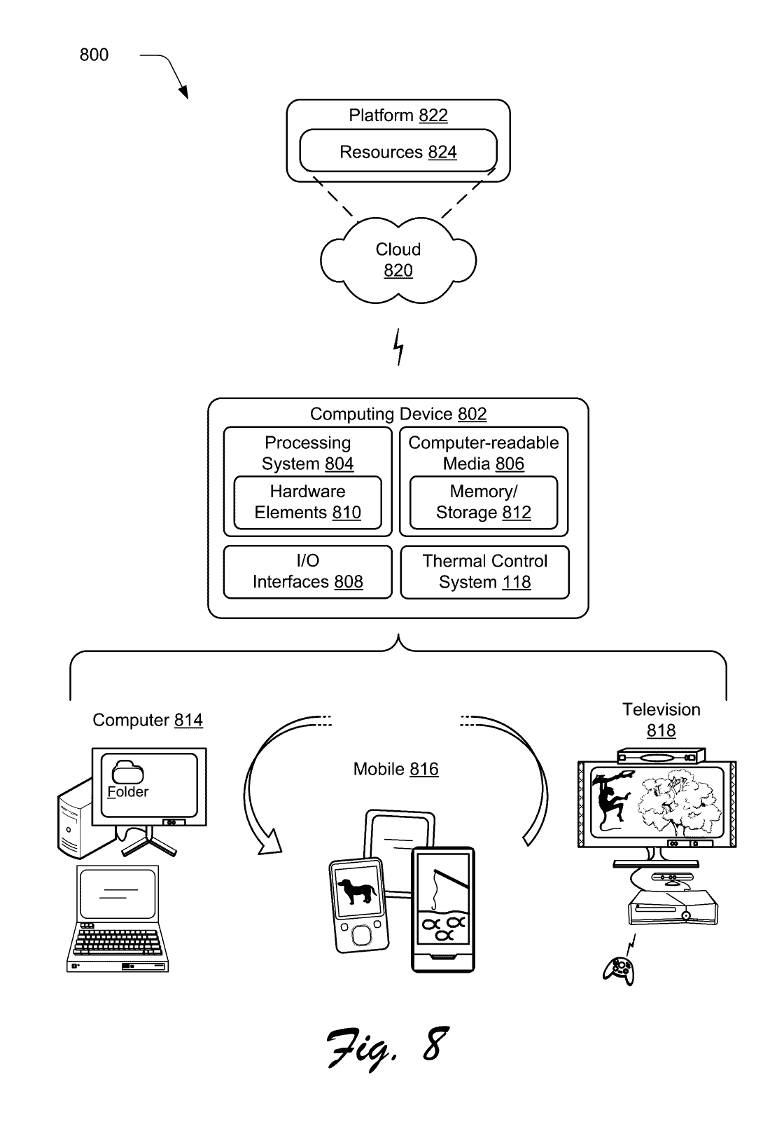

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on. Further discussion of different configurations that may be assumed by the computing device may be found in relation to FIG. 8.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, network, and/or display device 112 functionality of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102.

The computing device 102 may support a variety of different interactions. For example, the computing device 102 may include one or more hardware devices that a user may manipulate to interact with the device, such as a keyboard, cursor control device (e.g., a mouse, track pad, or touch device), and so on. The computing device 102 may also support gestures, which may be detected in a variety of ways. The computing device 102, for instance, may support touch gestures that are detected using touch functionality of the computing device 102. Sensors 114, for instance, may include a touch display module (TDM) 115 configured to provide touchscreen functionality in conjunction with the display device 112, as part of a track pad, via an external touch pad, or otherwise.

Recognition of the inputs may be leveraged to interact with a user interface output by the computing device 102, such as to interact with a game, an application, browse the internet, change one or more settings of the computing device 102, and so forth. The sensors 114 may also be configured to support a natural user interface (NUI) that may recognize interactions that may not involve touch. For example, the sensors 114 may be configured to detect inputs without having a user touch a particular device, such as to recognize audio inputs through use of a microphone or visual gestures using a camera based system.

The computing device 102 is further illustrated as including a power control module 116. The power control module 116 is representative of functionality to cause a device to enter different power consumption states. The processing system 104, for instance, may be configured to support a low power state in which processing resources are lessened and power consumption of the processing system 104 is also lessened. Thus, the processing system 104 may be configured to conserve resources (e.g., from a battery) while in this low power state.

During operation, the processing system 104 and other components may act as heat-generating devices that may produce heat levels in excess of “safe” limits if left unmitigated. As such thermal limits are approached, the computing device may have to be shutdown and/or operation of the processing system 104 may be throttled, which adversely affects performance. Accordingly, computing devices may include some type of thermal management system to manage heat-generating device.

In accordance with principles discussed in this document, the computing device 102 includes a thermal control system 118 used for thermal management. As discussed in the details section that follows, the thermal control system 118 is configured to account for non-uniformities in a temperature profile associated with arrangements of components within a housing of the computing device (e.g., the unmitigated profile). In order to do so, the thermal control system 118 includes a combination of active components 120 and passive components 122 designed to work together to compensate for temperature variations across the device surfaces. Working in combination, the active components 120 and passive components 122 produce a controlled temperature profile having greater uniformity and reduced overall differences in surface temperatures (e.g., a lower maximum temperature and a tighter range of temperatures).

Generally speaking, active components 120 refer to portions of the thermal control system 118 that rely upon active heat transfer, such as a ventilation system that uses forced air convection to transfer heat to air that is drawn through the device using a fan or blower. Liquid cooling and other active systems are also contemplated. Passive components 122 refer to portions of the thermal control system 118 that rely upon passive transfer means, such as natural conduction and radiation. Passive components are positioned to transfer heat to selected areas of the device using passive transfer devices, such as heat-pipes and thermal spreaders made of cooper and/or other conductive materials. The passive components 122 may be arranged to spread heat out to selected areas more evenly than would occur in arrangements limited to active components 120. Operating together, active components 120 and passive components 122 may achieve heat transfer through one or a combination of forced convection, natural convection, radiation, and conduction. Details regarding these and other aspects of combined active/passive thermal control are discussed in relation to the following figures.

Having considered the foregoing example operating environment, consider now a discussion of example details and procedures for combined active/passive thermal control in accordance with one or more implementations.

Combination Active/Passive Thermal Control Implementation Details

The section describes details and examples in accordance with one or more implementations. In general, functionality, features, and concepts described in relation to the examples above and below may be interchanged among one another and are not limited to implementation in the context of a particular figure or procedure. Moreover, blocks associated with different representative components and procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples in this description.

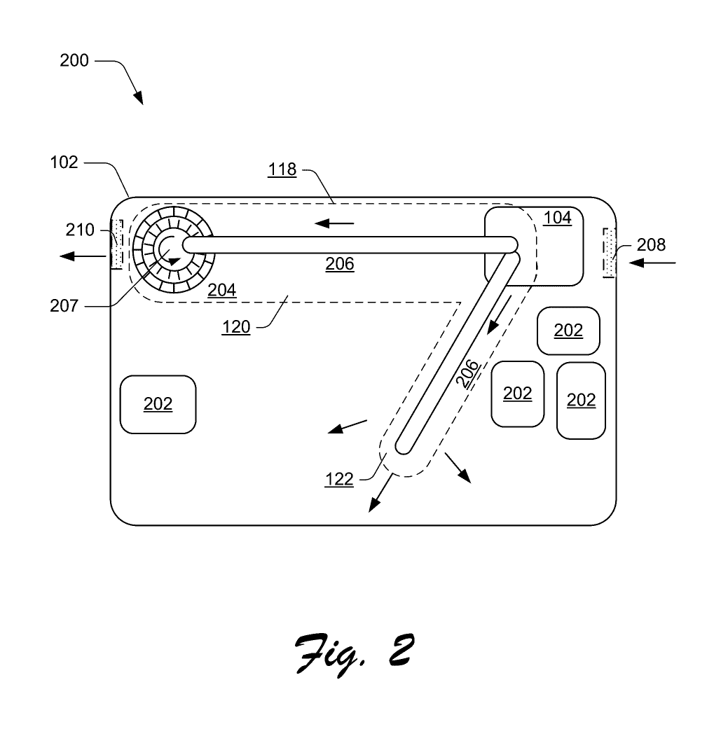

FIG. 2 depicts generally at 200 an example representation of a thermal control system 118 of FIG. 1 that employs a combination of active components 120 and passive components 122 in accordance with one or more implementations. In the example of FIG. 2, the thermal control system 118 is illustrated as being arranged within a housing of a computing device 102. The computing device 102 may include a plurality of heat-generating devices 202 that are depicted as being arranged throughout the housing in an arrangement. The heat-generating devices 202 may include a processing system 104 as described in relation to FIG. 1, as well as other components of the computing device such as a power supply unit, a battery, a microprocessor, and a graphics processor, to name a few examples. FIG. 2 additionally represents flow through the device for cooling of components of a corresponding computing device using arrows to show the general thermal flow directions.

In the example arrangement, the thermal control system 118 is configured to include a heat sink 204, one or more heat-transferring devices 206 used to convey heat away from the processing system 104 and/or other heat generating devices 202, and a blower 207 designed to cause air flow through the system for forced convective cooling. In particular, an active component 120 of the thermal control system 118 is represented in the form of a ventilation system that includes the heat sink 204, a heat-transferring device 206, and the blower 207. Another heat expelling device 206 is represented as a passive component 122 that operates in conjunction with the active component 120 as described above and below.

The heat sink 204 can be configured in various ways to accept, store, and dissipate heat that is communicated via the heat-transferring devices 206 to the heat sink. Generally, the heat sink device 204 operates as a heat exchanger that uses fins, pins, and/or other mechanical structures to increase surface area in contact with air or another cooling medium to facilitate heat dissipation. In accordance with techniques described in this document, the heat sink 204 may be arranged in conjunction with a suitable fluid mover that provides an active cooling mechanism for thermal control, such as the example blower 207.

The blower 207 is designed to pull air from an exterior of the housing through intake vents 208 into an interior of the housing. The blower 207 is representative of functionality to move and disperse cooling fluid for the system, which in this case is air. The blower 207 may be configured in various ways, such as being an axial fan or a centrifugal blower for moving air. Although aspects are described herein in relation to air cooling, comparable techniques may be used in connection with other types of fluid cooling systems that employ different types of gases and even liquids. Accordingly, pumps, impellers, different types of blowers, fans, and other types of fluid movers may also be employed in alternative designs and/or in conjunction with other types of cooling fluids. Additionally, although a single blower 207 and active component 120 is represented, multiple active components 120 and one or more corresponding fluid movers may be employed in various implementations.

In the depicted example, the blower 207 is designed to disperse air throughout the interior of the housing via one or more flow conduits to various heat-generating devices 202. Various types of flow conduits are contemplated such as channels that are formed in the housing, piping systems, tubes, manifolds, baffles, and so forth. Cooling air that is drawn into the device by the blower 207 and delivered to the heat-generating devices 202 operates to cool the device by convective transfer, which heats up the air. The heated air flows from the heat-generating devices 202 to exhaust vents 210 where the heated air is expelled from the system.

Heat-transferring devices 206 may be configured to transfer heat away from the heat-generating device 202 through use of thermal conductivity, phase transition, cooling fins, evaporation, heat sinks, and other techniques to convey heat away from the device. Heat-transferring devices 206 associated with the active component 120 may be used to draw heat away from various devices to the heat sink 204 for cooling. Similarly, heat-transferring devices 206 associated with the passive component 122 are used to convey heat to selected areas of the device and dissipate the heat through surfaces of the device using passive transfer mechanisms.

For example, the heat-transferring device 206 may be in the form of one or more heat pipes (as illustrated in FIG. 2) that are configured as enclosed tubes of thermally conductive material, e.g., a metal such as copper, and thus may conduct heat away from the heat-generating devices 202 using thermal conductivity. Heat may be drawn out actively to vents of the device, by natural conduction and radiation through device surfaces, and/or via other exhaust mechanisms. In addition or alternatively to using heat pipes, other types of techniques and components may be employed to draw heat away from the heat-generating devices, such as phase transition devices, vapor chambers, cooling fins, a heat sink, and so forth. Generally, any highly conductive device and/or materials may be used as a heat transfer mechanism.

As noted, the active and passive components operate together to compensate for temperature variations across the device surfaces and produce a controlled temperature profile having greater uniformity and reduced overall differences in surface temperatures. Thus, both the active and passive components operate at the same time (e.g., simultaneous operation) to produce a controlled temperature profile.

Various aspects of the thermal control system and active/passive components can be designed to spread the heat across the device surfaces and compensate for the unmitigated profile. In the absence of practical considerations including cost, available space, and other design constraints, sufficient active and passive components can be utilized in combination to create a substantially even heat distribution and a nearly isothermal profile for the device surfaces. Generally though, a thermal control system 118 having active/passive components is designed in light of practical considerations to achieve an acceptable level of balance in the controlled temperature profile that effectively reduces hot spots, creates a tighter range for surface temperatures, and provides improvements over traditional control arrangements.

In one or more implementations, the heat sink 204 and/or blower 207 are spaced apart from the heat source, such as having the heat sink 204 and processing system 104 generally on opposite sides of the device as represented in FIG. 2. Other arrangements are also contemplated, such as having the heat sink and heat source spaced apart top to bottom or in a diagonal arrangement relative to the device edges. In spaced apart arrangements including the noted examples, the active component 120 incorporates a heat-transferring device 206 that extends between the heat sink 204 and heat source. For example, the heat-transferring device 206 may extend at least partially along an edge or axis of the computing device, or in a diagonal or curved path between a heat sink and heat source. By doing so, the heat-transferring device 206 not only conveys heat from the heat source to the heat sink, but also transfers some heat to surfaces along a path that the heat-transferring device 206 traverses.

By way of example and not limitation, a heat-transferring device 206 in the form of a heat pipe in FIG. 2 extends laterally between the heat sink 204 and processing system 104 across substantially the entire length of the upper edge (e.g., across an x-axis of the example device). Characteristics of the heat pipe including the size, material, heat transfer coefficient, routing, taper, shape, and so forth can be adapted to control the profile along the edge across the device. Heat transfer occurs across the edge actively based on air that is drawn in by operation of the blower 207, as well as through conductive properties of the heat pipe. Arranging the active component 120 in this manner facilitates equalization of temperatures across the edge (or other path) and can provide a nearly isothermal profile for surfaces surrounding the active component 120. With the active component 120 positioned generally along an edge of the device as illustrated in FIG. 2, a substantially uniform profile is created in a portion of the device in which the active component 120 resides, which may correspond to roughly the entire upper half of the housing in the diagram.

In addition to having one or more active components 120, the thermal control system 118 includes one or more passive components 122. The passive components are designed to operate in combination with the active component(s) and further compensate for the non-uniformities in the temperature profile for the device. Generally, passive components 122 are arranged to transfer heat from one or more of the heat generating components 202 to selected areas having available capacity to dissipate the heat through passive means, such as natural conduction, radiation, and heat spreading. Selected areas may include lower temperature areas of the device as indicated by an unmitigated temperature profile for the device. In addition, the selected areas may correspond to areas apart from portions of the device including and being controlled through active components. Thus, the selected areas may be substantially unaltered by operation of the active components and therefore have potential for additional control over and balancing of the temperature profile of the device.

A passive component 122 is configured to convey heat to selected areas via one or more heat-transferring devices 206, examples of which were previously described. In the example of FIG. 2, the passive component 122 includes a heat-transferring device 206 in the form of a heat pipe. The example heat pipe of the passive component 122 extends from the heat source (e.g., processing system 104) to portion of the device and away from the portion of the device in which the active component 120 resides. For instance, the heat pipe may convey heat into areas that may have relatively lower temperatures and therefore capacity to dissipate additional heat. Design and placement of passive components may be based on thermal analysis of the device to determine the temperature profile on the surfaces without mitigation and/or with corrections from an active component individually. One or more passive components can be designed and added to the thermal control system to compensate for temperature gradients and non-uniformities that are indicated by the temperature profile. Thus, the passive components are implemented to provide additional heat spreading to selected areas that may be identified according to thermal analysis of the device.

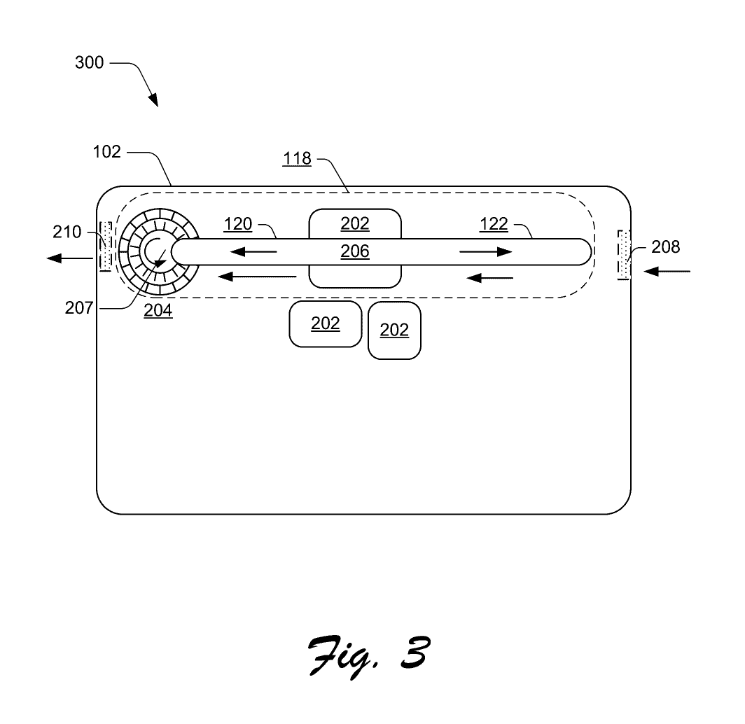

Spreading of heat in this manner using a passive component(s) in addition to an active component(s) provides further equalization of the temperature profile of the device surfaces and reduces temperature gradients across the surface. The result is a much more balanced temperature profile having moderate temperatures that may be difficult or impossible to achieve with active components alone. Various different arrangements of a thermal control system 118 that uses both active and passive components are contemplated, of which the arrangement depicted and described in relation to FIG. 2 is but one illustrative example. Some additional example arrangements and details are provided in discussion of FIGS. 3 to 5 that follows.

FIG. 3 depicts generally at 300 another example arrangement of a thermal control system 118 of FIG. 1 that employs a combination of active components 120 and passive components 122 in accordance with one or more implementations. In this example, heat-generating devices 202 are located in a center portion of the housing approximately at the midpoint of an edge of the device. The thermal control system 118 integrates an active component 120 that extends out from the heat-generating devices 202 towards one side of the device and a passive component 122 that extends out from the heat-generating devices 202 toward an opposite side of the device. By way of example, the active component 120 and passive component 122 may be implemented using a combined heat pipe (as illustrated), using separate heat pipes, or with other suitable heat-transferring devices. In this arrangement, the thermal control system 118 is designed to dissipate heat and balance the profile using a counter-flow mechanism. In particular, air is drawn in from the intake vent 208 and travels the length of the thermal control system 118 to the heat sink 204 and blower 207. Heated air is expelled via the exhaust vents 210. This represents active removal via the active component 120.

The passive component 122 is configured to draw at least some of the heat out from the source(s) towards the intake vent 208 in the opposite direction of the air flow. By doing so, heat is transferred to portions of the housing surrounding the portion of the heat pipe corresponding to the passive component, where the heat can be dissipated passively as well as via the counter-flow of air. An acceptable level of balance in the temperature profile along the length of the thermal control system 118 can be achieved by design of the active and passive portions to create the desired balance. For example, the sizes, shapes, and thermal properties of heat pipes for the active and passive component as well as characteristics of the heat sink and blower can be adapted to achieve a nearly uniform temperature profile.

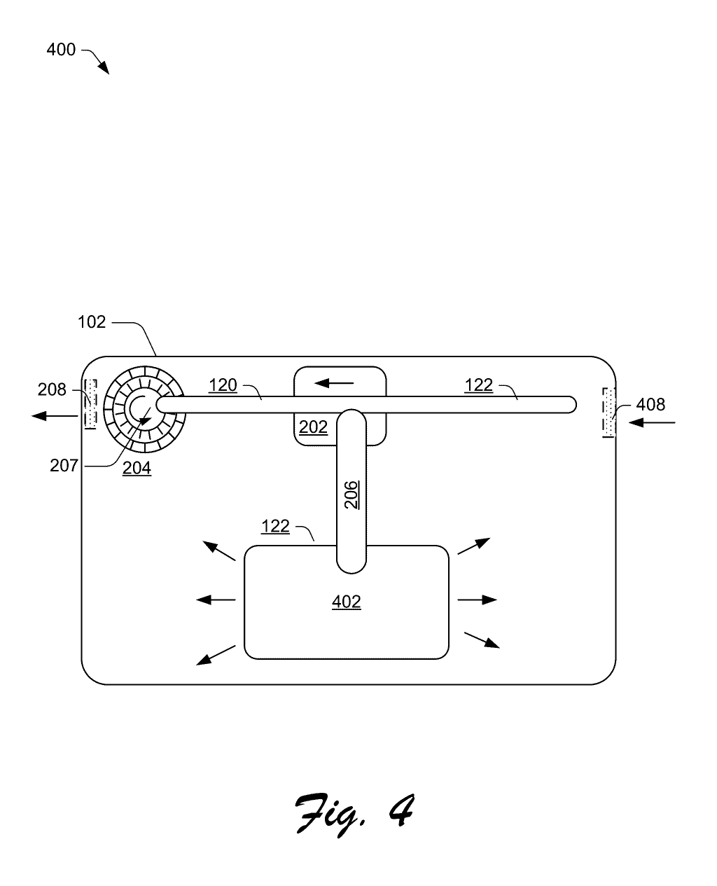

As mentioned, a thermal control system 118 as described herein may include one or more active components 120 combined with one or more passive components 122. FIG. 4 depicts generally at 400 an example arrangement of a thermal control system 118 of FIG. 1 that includes multiple passive components 122 in accordance with one or more implementations. Although not shown, a system having multiple active components 120 is also contemplated, such as by using two different blowers to control different heat sources and/or regions of the device.

In the example arrangement of FIG. 4, the thermal control system 118 integrates active and passive components that extend to opposite sides of the device as described in relation to the example arrangement of FIG. 3 combined with an additional passive component 122. In additional passive component 122 is designed to spread additional heat to selected areas of the device that are not “covered” by the other components of the thermal control system 118. In particular, the active/passive components as represented in FIG. 3 are routed along and are designed to balance the temperature profile of a path across substantially the entire length of the upper edge. As with the example of FIG. 2, this creates a uniform profile in a portion of the device (e.g., half of the housing) in which these active/passive components reside. Accordingly, the additional passive component 122 of FIG. 4 is included and routed generally to a different portion (e.g., a different, opposite half of the housing) of the device and away from the portion that is already being controlled by the other components. The additional passive component supplements the equalization provided by the other components by transferring heat to areas in the different portion of the device and thereby further reducing temperature gradients on device surfaces and/or lowering overall operating temperatures.

In the example of FIG. 4, the passive component 122 includes a heat-transferring device 206 in the form of a heat pipe that is connected to the heat generating device 202 at one end. Heat is conveyed away from the heat generating device 202 by conduction through the heat pipe into a portion or portions in the lower half of the diagram. In one or more implementations, a passive component 122 may further incorporate a heat spreader 402 that facilitates transfer and dissipation of heat to selected areas. In this example, the heat pipe is connected to the heat spreader 402 on an end that is opposite of the heat-generating device 202. Heat communicated from the heat-generating device 202 is transferred through the heat-pipe, into the heat spreader 402, and then out to portions of the device housing in proximity to the heat spreader 402.

A heat spreader 402 may be configured in various ways. Generally, the heat spreader 402 is a thin layer of conductive material that increases transfer areas in contact with the housing or other components to which heat is being directed. Heat spreaders 402 may be formed from various materials and have a variety of different sizes, shapes, thermal properties, and characteristics. By way of example and not limitation, the example heat spreader 402 in FIG. 2 has a generally rectangular shape. The heat spreader 402 may be formed as a thin metallic plate having a thickness of about 0.5 millimeters or less. Copper, silver, gold, or another conductive metal or alloy may be used to construct the heat spreader 402. Graphite based materials may also be employed.

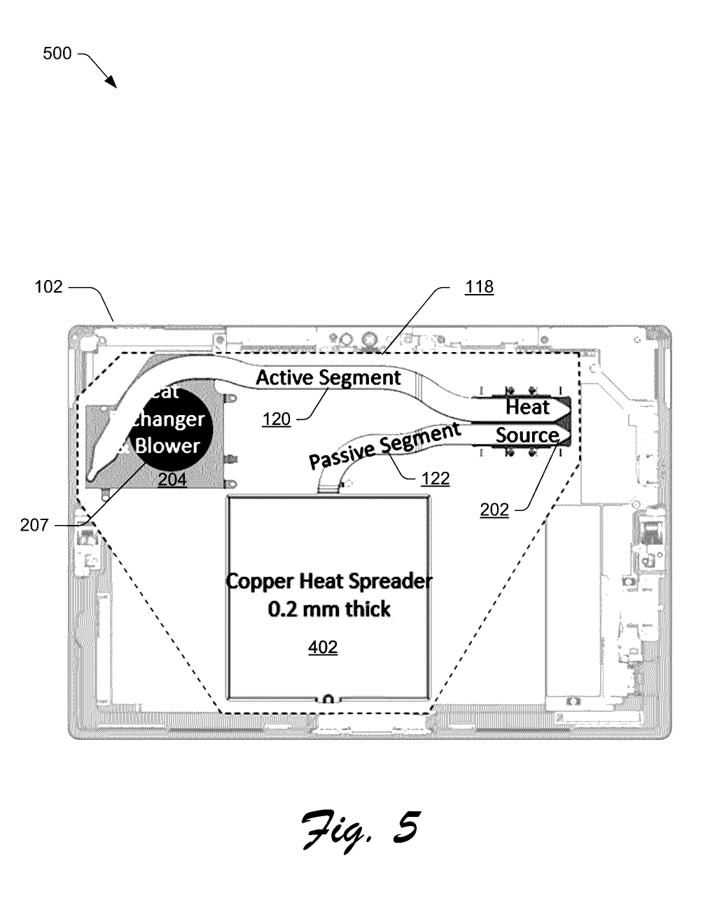

FIG. 5 depicts generally at 500 another example arrangement of a thermal control system 118 that employs a combination of active components 120 and passive components 122 in accordance with one or more implementations. In the depicted example, the thermal control system 118 is similar to the example arrangement discussed in relation to FIG. 2, which includes one active component 120 extending across an edge of the device that is combined with a passive component 122 positioned to transfer heat from an portion of the device to a different portion of the device. In addition, the passive component 122 in the arrangement of FIG. 5 includes a heat spreader 402 as discussed in relation to FIG. 4. Here, the heat spreader 402 is represented as a copper plate having a thickness of about 0.2 millimeter. Other implementations of heat spreader 402 as discussed previously are also contemplated.

In operation, the active component 120 equalizes the temperature profile across the edge and generally in a corresponding portion or half of the device in the manner described herein. The passive component 122 supplements the active component 120 by spreading the heat down to a different portion of the device away from the portion having the active component via the heat spreader 402. In accordance with principles discussed in this document, that heat sink/blower combination in FIG. 5 is spaced apart from the heat generating device 202 (e.g., heat source) to facilitate heat transfer in an even, balanced manner across the upper edge and portion of the device. Having the air intake opposite from the exhaust also causes incoming air to encounter the heat source with the highest temperatures first. The air then travels parallel to heat flow across the length of the active component 120 picking up heat across the length of the device and then exiting via the exhaust vents located proximate to the heat sink/blower. The system can be designed to have the air exit at maximum temperature (comparable to a concurrent flow heat exchanger). The use of a combination of active and passive approaches enables enlistment of multiple areas of the device housing and/or a large portion of the available surface area of the device (e.g., 25% or more) for heat removal through natural convection and radiant dissipation.

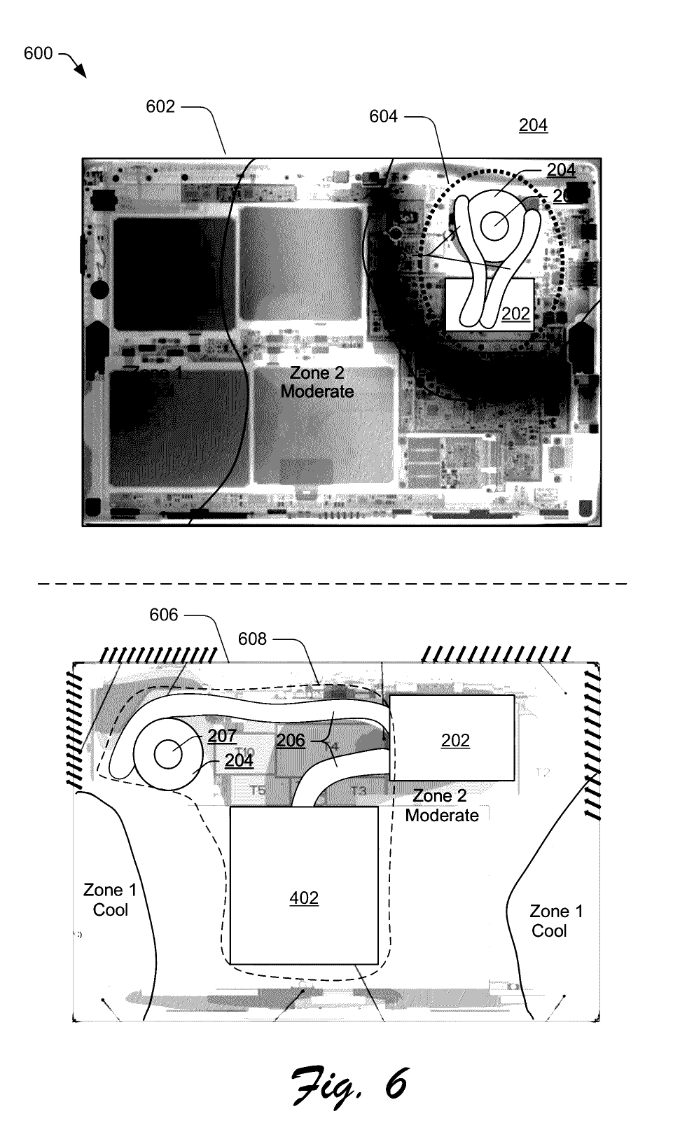

Consider now FIG. 6 which depicts generally at 600 a comparison of temperature profiles for devices having different configurations of thermal control systems. In particular, a device 602 having a traditional thermal control system 604 that uses just active components is compared with another device 606 having a thermal control system 608 configured with both active and passive components that are used in combination as described in this document.

Notice that the traditional thermal control system 604 is arranged compactly proximate to a heat-generating device 202 that it services. Such an arrangement may be utilized due to space constraints and to conserve weight and/or material cost. However, such arrangements have a drawback since the compact arrangement is unable to spread heat across the device surfaces. This can hamper heat dissipation and lead to hot spots and large temperature gradients on the device surfaces. A corresponding heat profile is represented by temperature zone bands in FIG. 6. Using the traditional thermal control arrangement, the zones produce include Zone 1 as a cool zone farthest away from the heat source and Zone 2 as a band of moderate temperatures between Zone 1 and the heat source. Zone 3 represents a hot spot that may be produced surrounding the heat source and thermal control system 604 due to the compact design of the system and limitations of the system to utilize device surfaces located away from the immediate area around the system for heat dissipation.

In contrast, the device 606 having a thermal control system 608 with both active and passive components has a controlled temperature profile that eliminates the hottest spots and generally has less variation across the device surface. In this arrangement, Zone 2 having moderate temperatures is produced for a large portion of the device surfaces in the areas generally surrounding a footprint of thermal control system 608. Relatively uniform temperatures result in Zone 2 and the temperatures can remain well within safe operating limits because heat is dissipated using more of the available surface area of the device.

In this particular arrangement, Zone 1 bands having cooler temperatures are also formed near the edges of the device in portions of the housing located generally between the heat spreader 402 and the edges. Here, the interior of the device corresponding to these portions is reserved to accommodate other device components such as a battery, a hard drive, memory, and or other devices. As such, the design may not permit extension of the heat spreader and/or other passive expelling devices into these regions. Consequently, the cooler bands of Zone 1 result. Depending on the device design, though, additional passive components could be included or the represented active/passive components could be adapted to achieve even greater uniformity, particularly in relation to the Zone 1 bands. For example, additional heat pipes could be routed from the heat source into the areas corresponding to the Zone 1 bands to further equalize surface temperature and minimize variation. Thus, the level of uniformity in the temperature profile that is achieved may reflect a tradeoff between multiple considerations including but not limited to cost, device design constraints, temperature constraints, available space in the device housing, and so forth.

Example Procedure

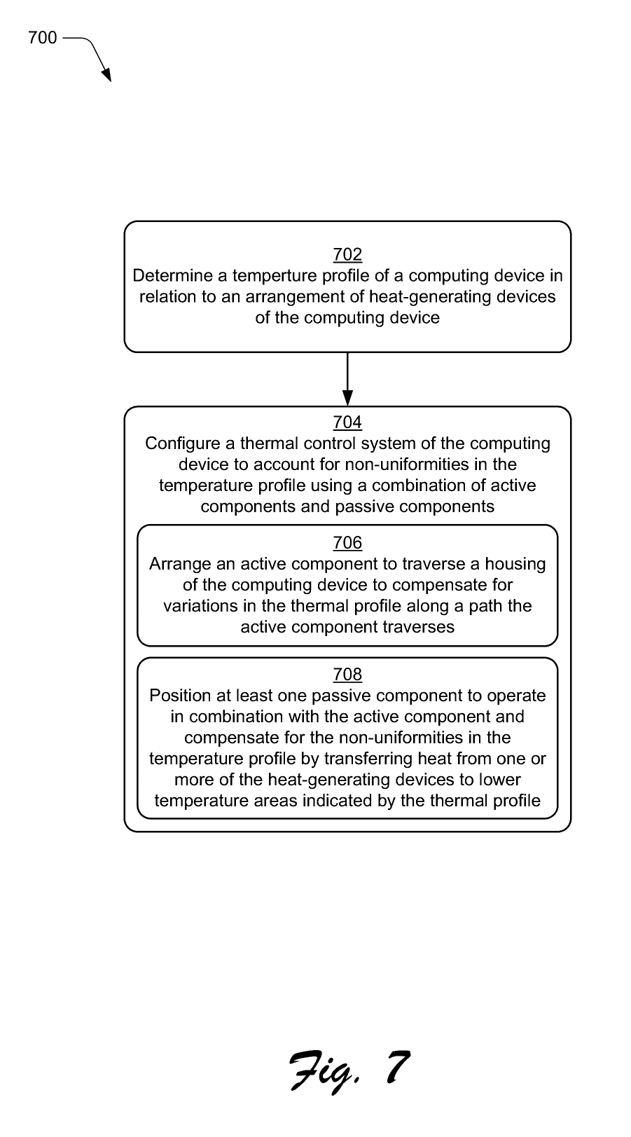

In the context of the forgoing example devices, techniques, and details, this section provides a discussion of an example procedure 700 of FIG. 7 that illustrates details of configuring a thermal control system in accordance with one or more implementations. The example procedure(s) described herein can be implemented in connection with any suitable hardware, software, firmware, or combination thereof

A temperature profile of a computing device in relation to an arrangement of heat-generating devices of the computing device is determined (block 702). For example, a thermal profile for a computing device 102 may be generated experimentally through thermal imaging or based on computer modeling of the system. The profile may show or otherwise indicate regions associated with different temperature characteristics and/or represent corresponding temperature bands. Thus, various non-uniformities, low temperature areas having heat removal capacity, and temperature gradients may be identified by analyzing the temperature profile. A temperature profile may be generated for one or both of an arrangement of heat-generating devices without thermal control (e.g., unmitigated) or following application of some partial thermal control. The temperature profile is used to design, adapt, and configure a thermal control system to account for variations indicated by the profile.

In particular, a thermal control system of the computing device is configured to account for non-uniformities in the temperature profile using a combination of active components and passive components (block 704). To do so, an active component is arranged to traverse a housing of the computing device and compensate for variations in the temperature profile along a path the active component traverses (block 706). For example, an active component 120 of a thermal control system 118 can be configured in various ways discussed in this document. The active component 120 includes a heat pipe or other heat-transferring device 206 that extends at least partially across the device to spread heat to corresponding surfaces in addition to active removal of heat. The heat pipe or other heat-transferring device 206 may be positioned proximate to an edge of the device, although arrangements in which the active component 120 traverses a path route through the interior of the device are also contemplated. In any case, transfer of heat occurs into surrounding areas along the path that the active component traverses. Additionally, the active component can implement forced convective heat transfer using air or another cooling fluid as discussed herein.

In addition to the active component, at least one passive component is positioned to operate in combination with the active component and compensate for the non-uniformities in the temperature profile by transferring heat from one or more of the heat generating components to lower temperature areas indicated by the temperature profile (block 710). For example, a passive component 122 of a thermal control system 118 can be configured in various ways discussed in this document. The passive component 122 can be designed and positioned within a device based on analysis of a temperature profile(s) for the device. In particular, the passive component 122 uses passive transfer mechanism such as conduction to convey heat to selected areas that may be identified according to the temperature profile. Suitable areas have relatively low temperatures in the profile that reflect capacity to accept and dissipate heat from higher temperature areas of the device. Thus, the passive component 122 can be designed to direct heat to portions of the device that are recognized as having capacity to remove heat. Using the passive component 122 in combination with the active component 120 enables fine control over the temperature profile to compensate for temperature variations that would otherwise exist across the device surfaces. The resultant corrected profile is generally free from hot spots, has lower overall temperatures, and greater uniformity across device surfaces. Additionally, larger heat transfer rates can be achieved using the described techniques in comparison to a device of the same size that does not employ combined active/passive control.

Having considered the foregoing example details and procedures related to implementations of a thermal control system that combines active and passive control, consider now a discussion of example systems, devices, and components that may be make use of thermal control systems as described herein in one or more implementations

Example System and Device

FIG. 8 illustrates an example system generally at 800 that includes an example computing device 802 that is representative of one or more computing systems and/or devices that may implement the various techniques described herein. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. The computing device may also include a thermal control system 118 as described herein. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable storage of information in contrast to mere signal transmission, carrier waves, or signals per se. Thus, computer-readable storage media does not include signal-bearing medium, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on. Computing device 802 may be a wearable device, such as a watch or a pair of eye glasses, or may be included in a household, commercial, or industrial appliance.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein.

Functionality may also be implemented all or in part through use of a distributed system, such as over a “cloud” 820 via a platform 822 as described below. The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

### EXAMPLE IMPLEMENTATIONS

Example implementations of techniques described herein include, but are not limited to, one or any combinations of one or more of the following examples:

### Example 1

A computing device comprising: a housing in which one or more heat-generating devices of the computing device are mounted in an arrangement; and a thermal control system for cooling the computing device including: one or more active components of the thermal control system configured to transfer heat away from the one or more heat-generating device by active heat transfer; and one or more passive components configured to operate in combination with the active one or more active components and positioned to transfer heat to selected areas of the device using passive transfer devices.

### Example 2

A computing device as described in any one or more of the examples in this section, wherein active heat transfer comprises forced convective cooling using a cooling fluid.

### Example 3

A computing device as described in any one or more of the examples in this section, wherein the one or more active components comprise a ventilation system that uses forced air convection to transfer heat to air that is drawn through the computing device.

### Example 4

A computing device as described in any one or more of the examples in this section, wherein the ventilation system includes a heat sink and a blower in thermal communication with at least one of the heat-generating devices via a heat pipe that extends between the at least one heat-generating device and the heat sink.

### Example 5

A computing device as described in any one or more of the examples in this section, wherein the heat pipe extends at least partially along an axis of the housing, such that heat is distributed evenly to device surfaces along a path that the heat-pipe traverses.

### Example 6

A computing device as described in any one or more of the examples in this section, wherein the heat sink and blower are spaced apart from the at least one heat-generating device along an edge of the device, such that the heat sink and blower are located on an opposite side of the housing from the heat-generating device and the heat pipe extends substantially along the entire edge.

### Example 7

A computing device as described in any one or more of the examples in this section, wherein the one or more passive components comprise one or more heat-transferring devices configured to transfer heat to selected areas having capacity to dissipate heat.

### Example 8

A computing device as described in any one or more of the examples in this section, wherein one or more passive components include at least a heat pipe connected at one end to at least one of the heat-generating devices and configured to transfer heat away from the at least one heat-generating device to an area of the device having capacity to dissipate heat.

### Example 9

A computing device as described in any one or more of the examples in this section, wherein the heat pipe is further connected to a heat spreader at an end opposite of the at least one heat-generating device.

### Example 10

A computing device as described in any one or more of the examples in this section, wherein the heat spreader is configured as a cooper plate.

### Example 11

A thermal control system for cooling of a heat source associated with a computing device comprising: an active component for mounting in a housing of the computing device in thermal communication with the heat source and arranged to provide cooling through forced convective heat transfer; and a passive component for mounting in the housing in thermal communication with the heat source, the passive component configured to operate in combination with the active component and arranged to provide cooling by transferring of heat away from the heat source and spreading of the heat into an area of the housing having capacity to dissipate heat

### Example 12

A thermal control system as described in any one or more of the examples in this section, wherein: the active component includes a heat sink and a blower connected to a heat pipe configured to traverse the housing between the heat source and a location in the housing for the heat sink and blower and connect the active component in the thermal communication with the heat source; the blower is configured to implement the forced convective heat transfer by drawing air from an intake vent through the housing and across a length of the heat pipe; the heat pipe is configured to conduct heat from the heat source to the heat sink and dissipate heat into the housing along a path the heat pipe traverses; and the heat sink is configured to facilitate dissipation of heat conducted via the heat pipe via mechanical structures that increase surface area in contact with air drawn through the housing by the blower.

### Example 13

A thermal control system as described in any one or more of the examples in this section, wherein the passive component comprises an additional heat pipe connected on one end to a heat spreader and connectable on an opposite end to the heat source, such that the additional heat pipe transfers heat away from the heat source into the heat spreader and the heat spreader dissipates heat received via the additional heat pipe through portions of the housing in proximity to the heat spreader.

### Example 14

A thermal control system as described in any one or more of the examples in this section, wherein: the heat sink and blower are spaced apart from the heat source along an edge of the housing, such that the heat pipe of the active component extends along the edge and the active component creates a substantially uniform profile for approximately a portion of the housing in which the active component resides; and the additional heat pipe of the passive component extends from the heat source away from the portion of the housing in which the active component resides into an different portion that includes the heat spreader and the area having capacity to dissipate heat.

### Example 15

A thermal control system as described in any one or more of the examples in this section, further comprising: an additional passive component for mounting in the housing in thermal communication with the heat source, the additional passive component configured to transfer heat away from the heat source into an additional area of the housing having capacity to dissipate heat.

### Example 16

A method comprising: determining a temperature profile of a computing device in relation to an arrangement of heat-generating devices of the computing device; and configuring a thermal control system of the computing device to account for non-uniformities in the temperature profile using a combination of one or more active components and one or more passive components.

### Example 17

A method as described in any one or more of the examples in this section, wherein configuring the thermal control system includes arranging an active component to traverse a housing of the computing device to compensate for variations in the temperature profile along a path the active component traverses.

### Example 18

A method as described in any one or more of the examples in this section, wherein configuring the thermal control system include positioning at least one passive component to operate in combination with the active component and compensate for the non-uniformities in the temperature profile by transferring heat from one or more of the heat-generating components to lower temperature areas indicated by the temperature profile.

### Example 19

A method as described in any one or more of the examples in this section, further comprising analyzing the temperature profile to identifying the lower temperature areas and designing the at least one passive component to direct heat to the lower temperature areas that are identified.

### Example 20

A method as described in any one or more of the examples in this section, wherein: the active component is configured to provide cooling through forced convective heat transfer using a cooling fluid; and the passive component is configured to provide cooling by transferring of heat away from the heat source using one or more heat-transferring devices.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computing device comprising:
a housing in which one or more heat-generating devices of the computing device are mounted in an arrangement; and
a thermal control system for cooling the computing device including:
one or more active components of the thermal control system configured to transfer heat away from the one or more heat-generating device by active heat transfer; and
one or more passive components configured to operate in combination with the active one or more active components and positioned to transfer heat to selected areas of the device using passive transfer devices.

2. A computing device as described in claim 1, wherein active heat transfer comprises forced convective cooling using a cooling fluid.

3. A computing device as described in claim 1, wherein the one or more active components comprise a ventilation system that uses forced air convection to transfer heat to air that is drawn through the computing device.

4. A computing device as described in claim 3, wherein the ventilation system includes a heat sink and a blower in thermal communication with at least one of the heat-generating devices via a heat pipe that extends between the at least one heat-generating device and the heat sink.

5. A computing device as described in claim 4, wherein the heat pipe extends at least partially along an axis of the housing, such that heat is distributed evenly to device surfaces along a path that the heat-pipe traverses.

6. A computing device as described in claim 4, wherein the heat sink and blower are spaced apart from the at least one heat-generating device along an edge of the device, such that the heat sink and blower are located on an opposite side of the housing from the heat-generating device and the heat pipe extends substantially along the entire edge.

7. A computing device as described in claim 1, wherein the one or more passive components comprise one or more heat-transferring devices configured to transfer heat to selected areas having capacity to dissipate heat.

8. A computing device as described in claim 1, wherein one or more passive components include at least a heat pipe connected at one end to at least one of the heat-generating devices and configured to transfer heat away from the at least one heat-generating device to an area of the device having capacity to dissipate heat.

9. A computing device as described in claim 8, wherein the heat pipe is further connected to a heat spreader at an end opposite of the at least one heat-generating device.

10. A computing device as described in claim 9, wherein the heat spreader is configured as a cooper plate.

11. A thermal control system for cooling of a heat source associated with a computing device comprising:
an active component for mounting in a housing of the computing device in thermal communication with the heat source and arranged to provide cooling through forced convective heat transfer; and
a passive component for mounting in the housing in thermal communication with the heat source, the passive component configured to operate in combination with the active component and arranged to provide cooling by transferring of heat away from the heat source and spreading of the heat into an area of the housing having capacity to dissipate heat.

12. A thermal control system as described in claim 11, wherein:
the active component includes a heat sink and a blower connected to a heat pipe configured to traverse the housing between the heat source and a location in the housing for the heat sink and blower and connect the active component in the thermal communication with the heat source;
the blower is configured to implement the forced convective heat transfer by drawing air from an intake vent through the housing and across a length of the heat pipe;
the heat pipe is configured to conduct heat from the heat source to the heat sink and dissipate heat into the housing along a path the heat pipe traverses; and
the heat sink is configured to facilitate dissipation of heat conducted via the heat pipe via mechanical structures that increase surface area in contact with air drawn through the housing by the blower.

13. A thermal control system as described in claim 12, wherein the passive component comprises an additional heat pipe connected on one end to a heat spreader and connectable on an opposite end to the heat source, such that the additional heat pipe transfers heat away from the heat source into the heat spreader and the heat spreader dissipates heat received via the additional heat pipe through portions of the housing in proximity to the heat spreader.

14. A thermal control system as described in claim 13, wherein:
the heat sink and blower are spaced apart from the heat source along an edge of the housing, such that the heat pipe of the active component extends along the edge and the active component creates a substantially uniform profile for approximately a portion of the housing in which the active component resides; and
the additional heat pipe of the passive component extends from the heat source away from the portion of the housing in which the active component resides into an different portion that includes the heat spreader and the area having capacity to dissipate heat.

15. A thermal control system as described in claim 11, further comprising:
an additional passive component for mounting in the housing in thermal communication with the heat source, the additional passive component configured to transfer heat away from the heat source into an additional area of the housing having capacity to dissipate heat.

16. A method comprising:
determining a temperature profile of a computing device in relation to an arrangement of heat-generating devices of the computing device; and
configuring a thermal control system of the computing device to account for non-uniformities in the temperature profile using a combination of one or more active components and one or more passive components.

17. A method as described in claim 16, wherein configuring the thermal control system includes arranging an active component to traverse a housing of the computing device to compensate for variations in the temperature profile along a path the active component traverses.

18. A method as described in claim 17, wherein configuring the thermal control system include positioning at least one passive component to operate in combination with the active component and compensate for the non-uniformities in the temperature profile by transferring heat from one or more of the heat-generating components to lower temperature areas indicated by the temperature profile.

19. A method as described in claim 18, further comprising analyzing the temperature profile to identifying the lower temperature areas and designing the at least one passive component to direct heat to the lower temperature areas that are identified.

20. A method as described in claim 19, wherein:
the active component is configured to provide cooling through forced convective heat transfer using a cooling fluid; and
the passive component is configured to provide cooling by transferring of heat away from the heat source using one or more heat-transferring devices.
